(19) United States
(12) Patent Application Publication
(10) Pub. No.: US 2013/0243512 A1
(43) Pub. Date: Sep. 19, 2013

(54) PRINTER WITH LABEL SELF-STRIPPING MECHANISM

(71) Applicants: TER LIANG TONG, Singapore (SG); HUAT LAI CHEAH, Singapore (SG)

(72) Inventors: TER LIANG TONG, Singapore (SG); HUAT LAI CHEAH, Singapore (SG)

(73) Assignee: INTERMEC IP CORP., Everett, WA (US)

(21) Appl. No.: 13/421,027

(22) Filed: Mar. 15, 2012

(51) Int. Cl. B41J 13/00

(52) U.S. Cl. 400/644

(57) ABSTRACT

A printer is described herein that is equipped to internally remove the backings off of self-adhesive label paper, exposing an adhesive layer when ejected from the printer. A user desiring to print some sort of indicia on the self-adhesive paper need only initiate printing, and a label with exposed adhesive is ejected from the printer. A print side of the paper is split from a backing inside the printer pulling preceding print sides and backings at certain tensions, thereby creating a particularly effective separation angle. A ribbon break shaft and one or more rollers create the correct tension in the print sides, while a platen roller and cantilever leaf spring create the correct tension in the backings. In some embodiments, the optimal separation angle lies between 19 and 25 degrees.

### BACKGROUND

Self-adhesive labels serve many purposes and are vital to different businesses. Shipping addresses, bar codes, name tags, and various other indicia are commonly printed on self-adhesive paper for different reasons. As smaller and smaller resolution printing becomes possible with modern printers, tinier labels can be (e.g., ¼, ½, or 1 inch in length) are becoming popular access different industries like electronics and manufacturing. Labels today are printed on paper or other media with a side for printing affixed to a wax or some other synthetic backing that can be removed once the label is ready to be stuck on something. Once printed, labels need to be separated from the backing by hand to reveal the adhesive portion of the labels. Doing so can be very tedious to people who constantly need to print and stick labels. A printer generating labels throughout the day may require workers to constantly remove printed address labels all day long, which can quickly become repetitive day in and day out.

Label paper typically includes a top side to be printed on with adhesive stuck to a backing. Once a desired indicia, label, or other marking is printed on the top side, the label paper—top side still affixed to the underside—is sent out of the printer for a user to pick up. The user can then peel the top side away from the backing, revealing the adhesive that can be used to adhere the label to a something, but afterward, the user must discard the backing. Constantly tearing labels away from backings is time consuming for the user, and discarded backings, if not properly thrown away, can quickly clutter an area.

Stripping a label from a backing is a difficult task to perform mechanically by a printer. Stripping the label too quickly may result in the label tearing, not separating uniformly, or overturning within the printer and causing a jam. Stripping too slowly may give the label time to reattach to the backing. To perform properly, a printer must reliably separate every label; otherwise, jamming or other functional problems will ensue. Efficient printers lie at the backbone of today's business community, so printer malfunctions can be quite costly in the work environment.

### SUMMARY

This summary is provided to introduce a selection of concepts in a simplified form that are further described below in the Detailed Description. This summary is not intended to identify key features or essential features of the claimed subject matter. Nor is this summary intended to be used as an aid in determining the scope of the claimed subject matter. In fact, some embodiments may include features not specifically described in this summary, or other features generally well known to those skilled in the art.

One aspect of the invention is directed to a printer that internally separates the backings from the print sides of self-adhesive paper. Rollers inside the printer feed the self-adhesive paper to a printing area and a self-stripping area. Once a desired label, ticket, or other indicia is printed on the print side of the self-adhesive label in the printing area, the backing of the self-adhesive paper is removed in the self-stripping area. As a result, an adhesive side underneath the print side is exposed before the print side is ejected from the printer. The removed backing is eventually collected inside the printer so that a technician or other person may later remove all removed backings at once.

During separation, the backing is removed from the print side at a specific angle created by tensions in previous separations of print sides and backings. In other words, previously separated print sides and backings are pulled and forced through the printer in such a manner as to create the separation angle for backing removal. A ribbon break shaft and one or more rollers govern the tension on the print side of the self-adhesive paper. While a platen roller and a cantilever leaf spring create the appropriate tension on the backing side. The separation angle generally ranges between 19 and 25 degrees, and one embodiment precisely uses a 21.75 degree angle. These angles consequently produce more even label separation than other techniques, resulting in less printer jamming or malfunctioning, and removing the need for people to peel printed labels from backings.

Another aspect is directed to an internal process inside a printer for automatically removing the backing of a self-adhesive label. Once a user requests printing on the self-adhesive paper, the self-adhesive paper is fed to a self-splitting ledge that removes a backing from a print side at a specific angle. Doing so requires specific tensions in previously separated print sides and backings. Rollers pull the sheet of the previously separated print sides toward an eject slot in the printer, while a ribbon break shaft forces newly separated print sides down. As for the backing sheet, tension is created by a paten roller and cantilever leaf spring directing backings to a collector roll for a technician to later remove. Once split from a backing, a print side with underlying adhesive exposed is ejected from the printer to a user. Edges of a particular label may be demarcated with perforations that can be torn to create the desired printing, or the printings may be cut with a cutting bar inside the printer before being ejected. Eventually, a printer user is presented with a desired printing with an exposed adhesive side, thus alleviating the need for the user to peel the printing from a backing.

### BRIEF DESCRIPTION OF THE SEVERAL VIEWS OF THE DRAWINGS

The present invention is described in detail below with reference to the attached drawing figures. These drawings are provided to illustrated several different embodiments of the present invention, though perhaps not all embodiments. The respective descriptions herein aid in the teachings of the drawings. The following drawings are included with in this disclosure:

FIG. 1 is a diagram of a printer capable of printing self-adhesive paper without a backing, according to one embodiment of the present invention;

FIG. 2 is a side view of a printer capable of internally stripping self-adhesive paper from a backing, according to one embodiment of the present invention;

FIG. 3 is a diagram of a self-stripping mechanism and platen roller, according to at least one embodiment of the present invention;

FIG. 4 is a block diagram of different parts of a self-stripping mechanism, according to at least one embodiment of the present invention; and

FIG. 5 is a diagram of a work flow for automatically removing the backings from print sides of self-adhesive paper, according to one embodiment of the invention.

### DETAILED DESCRIPTION

The subject matter described herein is presented with specificity to meet statutory requirements. The description herein is not intended, however, to limit the scope of this patent. Instead, the claimed subject matter may also be embodied in other ways, to include different steps or combinations of steps similar to the ones described in this document, in conjunction with other present or future technologies. It should be noted that the claims govern the confines of the invention and may recite different combinations of feature than the combinations described herein.

Embodiments of the present invention are directed to a printer with a splitting mechanism for automatically separating the backing from self-adhesive paper before being ejected from the printer. The embodiments allow printed labels, stickers, tickets, or other indicia to easily be printed on self-adhesive paper and presented to a person such that the adhesive side of the paper is already exposed. Being separated inside the printer means a printer user does not have to manually peel a label from a backing, and saving the user the hassle of having to peel and discard a backing.

Self-adhesive label paper is discussed mentioned in relation to different embodiments of the invention. To clarify, self-adhesive paper refers to paper that includes a side for printing with an underlying adhesive side and a backing affixed to the adhesive side. Upon separation, the backing is removed and the adhesive side is exposed. One skilled in the art will appreciate that the print side may comprise some type of printable paper stock acting as a receptacle for printed labels, tickets, or other indicia. The adhesive side may be a uniform or patterned adhesive or sticky material on the back of the print side. The backing may be any sort of label or adhesive backing, such as, for example, a wax paper or other synthetic material. Embodiments are not limited to label paper requiring an adhesive side, however. Any type of paper needed separated may be used; however, for the sake of clarity, self-adhesive paper is referenced herein to describe different embodiments.

Embodiments mentioned herein reference two sheets after splitting: (1) a print-side sheet that includes successive sides for printing with an exposed adhesive side; and (2) a backing sheet that includes the successively stripped backings. While discussed in further detail below, the self-strip ledge may separate the paper in a number of different ways. The paper may include one or more perforations that are caught on the self-strip ledge and that wedges the paper in a separated print with underlying adhesive and a backing. Instead of using perforations, the self-strip ledge may wedge the paper in two at some indention, cutout, or edge of the paper. Other embodiments may alternatively use suction or an adhesive arm instead of the self-strip ledge to separate the print side from the backing. Further still, different temperatures or heating techniques may be applied for separating the paper. Thus, numerous wedging and separating techniques can be used and are fully contemplated by the present invention.

One embodiment of the present invention is directed to a printer equipped with one or more rollers feeding self-adhesive paper to a printing area. As one skilled in the art will appreciate, self-adhesive paper typically includes a print side with underlying adhesive affixed to a backing side. After printing, the printer feeds the self-adhesive paper to a self-strip ledge that separates the print side from the backing, thus revealing the adhesive. The two sides of the self-adhesive paper may be pulled through various areas of the printer in long sheets. Indications of labels successively perforated, stamped, or marked thereon.

Certain tensions are maintained on each sheet to ensure the self-adhesive paper separates at a specific angle determined to be highly superior for automatic peeling of the self-adhesive paper. To create the appropriate tension in the backing side, an arcuately rotating platen roller pulls the backings, and a cantilever leaf spring applies a force to the platen roller to aid the platen roller in creating the tension. For the print-side sheet, one embodiment employes one or more rollers to pull the separated sheet toward an outlet slot of the printer where self-adhesive labels are ejected. Additionally, a ribbon print break shaft may apply pressure to the print-side sheet, keeping the print-side sheet in a specific area of the printer. Using certain tensions in the two sheets allows print sides to be separated from backings at the specific separation angle. In at least one embodiment, the angle is 21.75 degrees, which was shown to be optimal upon testing. Alternatively, the angle may vary between 19 and 25 degrees. Or other angles may be used in different embodiments depending on paper weight, paper type or stock, roller size or rotational speeds, pressure from the cantilever leaf spring or ribbon break shaft, or some other factors.

Another embodiment is directed to a method, performed inside a printer, for successively creating self-adhesive printed paper by separating a print side from a backing. In this embodiment, an arcuately rotating platen roller pulls previously separated backings of the paper across a roller, producing a tension in the backing. A ribbon break shaft, or other stopper, applies a force to print sides of the paper that have previously been separated—i.e., already-split print sides—and one or more rollers pull the previously split print sides. The ribbon break shaft and the roller(s) thus create a tension in the print-side sheet that, when combined with the tension in the backing sheet from the platen roller, allows a self-strip ledge to separate a print side from a backing at a specific angle. Again, the angle may vary in different embodiments, such as, for example, 21.75 degrees in one embodiment, between 19-25 degrees in another embodiment, or at some other angle.

Having generally described an overview of a few embodiments of the present invention, attention is focused on the drawings for further illumination. The drawings merely provide illustrations for explanatory purposes, and are not necessarily meant to construed claimed embodiments to any particular mechanisms or machinations. In fact, some embodiments may include components, devices, or other parts not shown in the drawings.

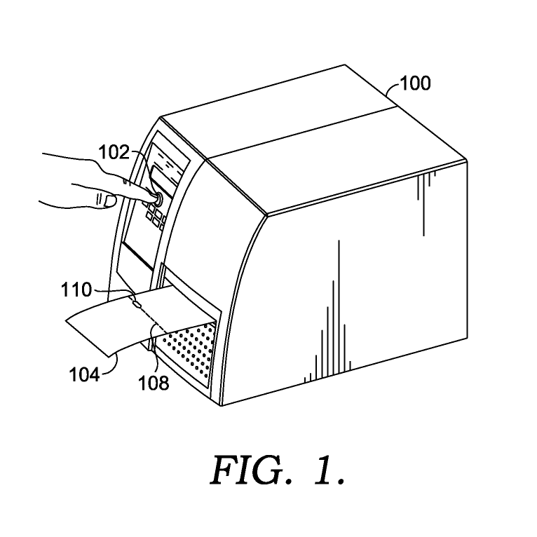

FIG. 1 is a diagram of a printer capable of printing self-adhesive paper without a backing, according to one embodiment of the present invention. As shown, a user presses button 102 to initiate printing a ticket, label, or other indicia on print side 104 of a piece of self-adhesive paper. Insider printer 100, the backing affixed to print side 104 is removed before print side 104 is ejected to the user. Print side 104 may be sectioned off in standardized increments (e.g., ¼inch, ½inch, 1 inch, etc.), as indicated by perforations 108. These perforations allow the self-adhesive paper to easily be torn away in successive increments of the same size. It may not be desirous to have printed labels of the same size, however, so alternative embodiments may not use perforations 108. In those scenarios, printer 100 may be equipped with teeth, a cutting bar, or other mechanism to separate print side 104 from a sheet of the self-adhesive paper. One skilled in the art will understand that numerous different techniques may be used for cutting print side 104 to particular lengths and those techniques are fully contemplated by the embodiments of the present invention.

Print side 104 also includes indention 110, which is a particular perforation used in one embodiment to effectuate internally splitting print side 104 from a backing. In operation, a self-stripping ledge or bar wedges between print side 104 and the backing at indention 110, prying the two pieces apart. While shown as an accentuated perforation in FIG. 1, indention 110 may take many different forms, so embodiments are not limited to the indention 110 shown. Alternative to what is shown in FIG. 1, indention 110 may be located anywhere on print side 104, on an edge of both print side 104, or on a backing instead of print side 104. The latter scenario may be particularly advantageous because separated print side 104, when ejected to a user, would not include a notched look from an accentuated indention 110 and thus would be much cleaner looking.

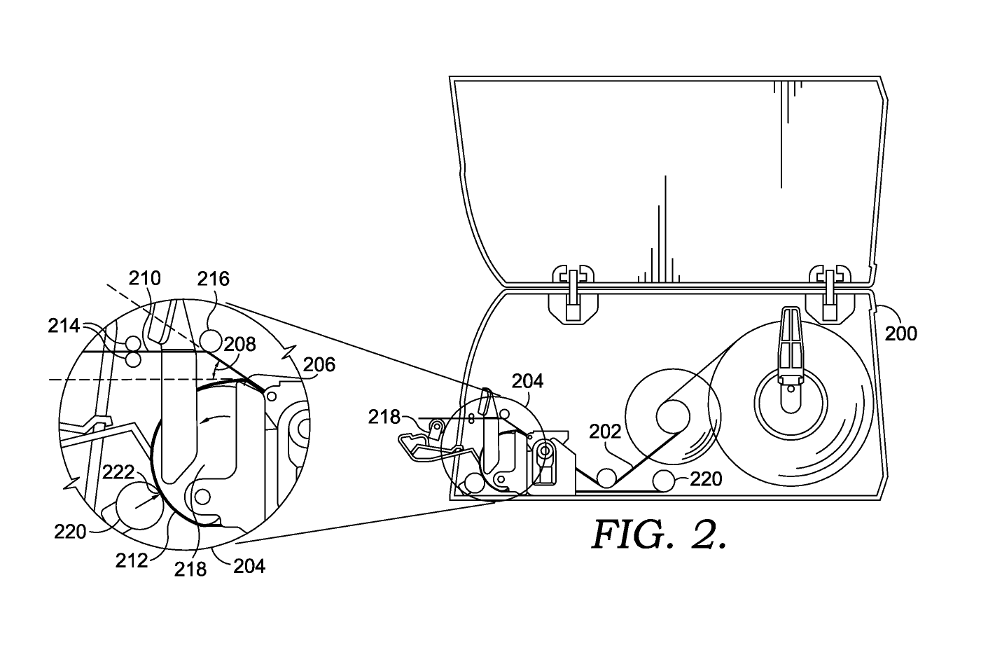

FIG. 2 is a side view of a printer capable of internally stripping self-adhesive paper from a backing, according to one embodiment of the present invention. Printer 200 is depicted with a side door open to reveal various inner workings and mechanisms inside. A feed 202 of self-adhesive paper is conveyed through printer 200 for printing and then automatic stripping of the self-adhesive paper's backing. The specifics of printing need not be discussed at length herein, as one skilled in the art will generally understand different configurations (e.g., laser, thermal, etc.) can be used to print indicia on the self-adhesive paper.

After printing, the self-adhesive paper is directed to separation area 204 including a self-strip ledge 206 that is responsible for separating print sides from backings of the self-adhesive paper. Self-strip ledge 206 may be made of any type of plastic, metal, or other rigid material capable of wedging between a print side and of a backing of self-adhesive paper. Perforations, indentions, edges, or other openings in either the print side or the backing may act as the point at which self-strip ledge 206 starts to wedge the two apart. In one embodiment, self-strip edge 206 splits the print side from the backing at angle 208 (e.g., 21.75 degrees, 19-25 degrees, or some other angle). In such an embodiment, angle 208 of splitting is created by the generating certain tensions in sheets of previously separated print sides 210 and backings 212. Pulling sheets 210 and 212 at the appropriate tensions ensures self-splitting ledge 206 separates the print side from the backing at the specified angle.

For print-side sheet 210, tension is created by the rollers 214 pulling previously separated print sides and ribbon break shaft 216 forcing newly separated print sides downward. In this way, ribbon break shaft 216 acts as somewhat of a barrier as rollers 214 guide newly separated print sides out of printer 200. While two rollers 214 are depicted, some embodiments may use additional or fewer rollers. Some embodiments may not use rollers 214 to pull separated print sides from self-stripping ledge 206, opting instead to employ other modes of conveyance.

Arcuately rotating platen roller 218 works with cantilever leaf spring 220 to pull backing sheet 212 away from self-strip ledge 206 at angle 208. In particular, cantilever leaf spring 220 tangentially applies pressure at point 222 in order to create the appropriate tension in backing sheet 212. Embodiments do not require cantilever leaf spring 220, however, as other mechanisms may be used to apply the appropriate tangential pressure to platen roller 218. Platen roller 218 directs backing sheet 212 to roller 220, which conveniently collects and stores the removed backings. A person can then remove the summarily collected backings and dispose of the backings all at once, eliminating the need to throw each backing away individually and creating a far easier way to discard backings from label paper.

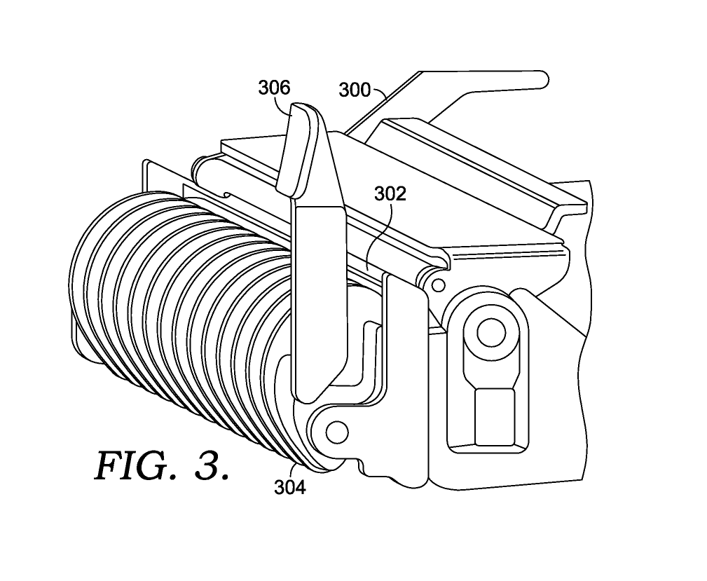

FIG. 3 is a diagram of a self-stripping mechanism and platen roller, according to at least one embodiment of the present invention. Self-stripping mechanism 300 includes a self-strip ledge 302 and a platen roller 304. Self-stripping ledge 302 may be made from any type of rigid metal or plastic. Platen roller 304 may be made from silicon rubber, wood, plastic, or metal, and, in one embodiment, helps create pressure on label paper during printing to ensure clean printouts. Also shown, thought not required in all embodiments, lever 306 provides a easy locking mechanism for inserting and removing self-stripping mechanism into a printer. One skilled in the art will understand, however, that many alternative locking or connecting mechanisms may be used to insert or remove the self-stripping mechanism in a printer. Therefore, embodiments should not be construed to require a lever or any other interlocking mechanism.

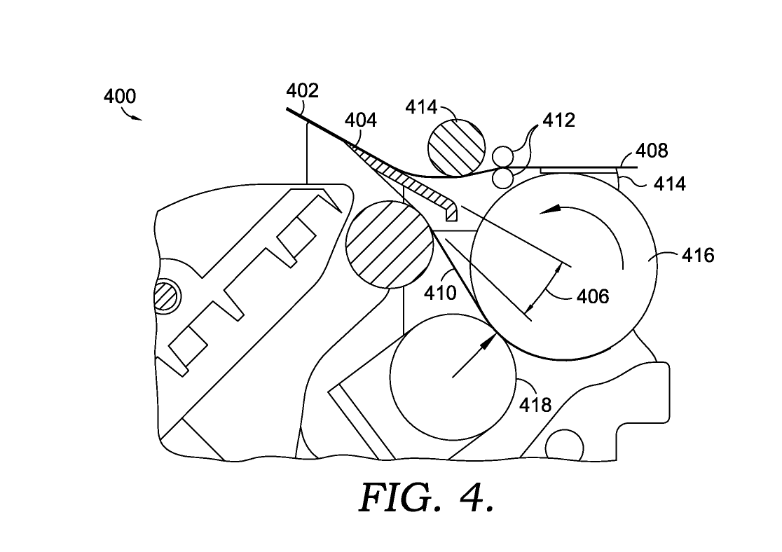

FIG. 4 is a block diagram of different parts of a self-stripping mechanism, according to at least one embodiment of the present invention. Self-stripping mechanism 400 feeds paper 402 to self-stripping ledge 404 to be separated at angle 406. Maintaining specific tensions in sheets 408 and 410 produce the appropriate angle 406 for splitting a print side from a backing. Rollers 412 and ribbon break shaft 414 create the tension in print-side sheet 408. Platen roller 416 and cantilever leaf spring 418 create the tension in backing sheet 410. Removing the backing in such a way allows only the print side with an exposed underlying adhesive to be ejected from the printer to a user.

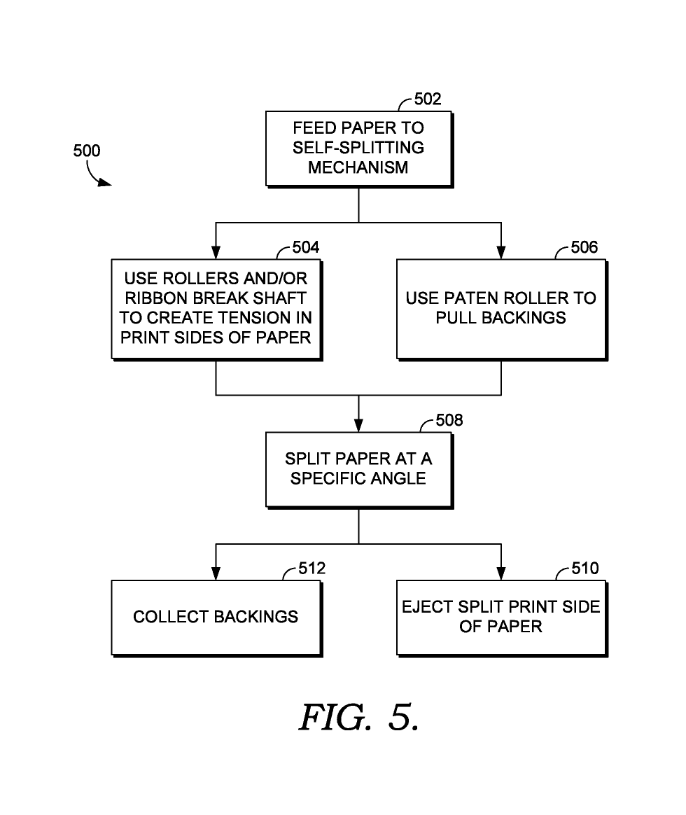

FIG. 5 is a diagram of a work flow for automatically removing the backing of a self-adhesive label inside a printer, according to one embodiment of the invention. Once a user requests printing on the self-adhesive paper, flow 500 begins by feeding the self-adhesive paper to a self-splitting mechanism, as shown at block 502. The self-splitting mechanism works to remove a backing from a print side of a self-adhesive label at a specific angle. To do so, tensions are created and maintained in previously separated print sides and backings. Rollers pull the sheet of the previously separated print sides toward an eject slot in the printer, while a ribbon break shaft forces newly separated print sides down. Such a step is indicated at block 504. As for the backing sheet, tension is created by a cantilever leaf spring pressing on a patent roller that directs backings to a collector roll for later removal by a technician or other person. Such a step is shown at block 506.

As mentioned several times before, the two sheet tension work to create a precise angle for splitting print sides from backings, as indicated at 508. For some embodiments of the invention, though not necessarily all, a separation angle of 21.75 degrees proves highly effective in separating self-adhesive paper with little or no fault. Other embodiments of the invention may use different angles (e.g., 19-25 degrees) depending on the stock or liner of paper, speed of rollers, tensions created in the print sides or backings, or other factors. Therefore, embodiments of the invention are not particularly limited to any specific separation angle, as different circumstances may necessitate different angles.

Once split from a backing, a print side with underlying exposed adhesive is ejected from the printer to a user, as indicated at block 510. In one embodiment of the invention, a user-requested printing is demarcated with perforations that can be torn to create the desired printing. Alternatively, the adhesive-exposed print side can be cut by a cutting bar inside the printer to create the desired printing. Various other alternative techniques may be used for outputting the desired printing, as embodiments may use different ways to create specifically sized printings than just simply printing labels on backings and leaving the user to remove backings.

As shown at block 512, The removed backings are collected, in sheet form, inside the printer. The collection may occur around a roll, spool, or in some other depository that can easily be removed by a technician or person who opens the printer. Or, in alternative embodiments of the invention, a self-eject mechanism may be included in the printer to eject a roll or removed backings at the touch of a button. However the backings are removed, neatly collecting all the backings inside the printer eliminates the need for users to peel and throw away backings themselves. The end result is far less mess or hassle for generating and discarding self-adhesive paper.

The illustrated steps are not limited to a sequential manner, as some embodiments will perform the steps in parallel or out of the sequence illustrated. Furthermore, although the subject matter has been described in language specific to structural features and methodological acts, it is to be understood that the subject matter defined in the appended claims is not necessarily limited to the specific features or acts described above. Instead, the specific features and acts described above are disclosed as example forms of implementing the claims. For example, multiple rollers may be used to create the effects shown by one or more rollers described herein, or specific separation angles may be different than those discussed. Different printing, scoring, indentation, or marking techniques may be used to demarcate labels. Also, the subject matter in the appended claims may include any number of the previously mentioned features than what has been described herein.

The invention claimed is:

1. A printer, comprising:
a feed of self-adhesive label paper with a print side and an adhesive side, the adhesive side being affixed to a backing;
a ribbon break shaft that applies a first force to the print side during separation from the backing;
a roller that applies a second force to the backing during separation from the print side; and
a self-strip ledge to remove the print side from the backing at a predefined angle created by the first and second forces.

2. The printer of claim 1, a platen roller that arcuately rotates and directs the backing, after being separated from the print side, to an area within the printer for collecting separated backings.

3. The printer of claim 2, further comprising group of one or more rollers directing the backing to a collection roll within the printer.

4. The printer of claim 1, wherein the predefined angle that the print side is separated from the backing ranges between 19 and 25 degrees.

5. The printer of claim 1, wherein the predefined angle that the print side is separated from the backing is 21.75 degrees.

6. The printer of claim 1, further comprising an output slot on the printer through which the print label is ejected.

7. The printer of claim 1, further comprising:
a platen roller that arcuately rotates and directs the backing, after being separated from the print side, to an area within the printer for collecting separated backings; and
a cantilever leaf spring applying pressure to the platen roller to produce a tension within the backing after being separated from the print side.

8. The printer of claim 1, wherein the self-adhesive label paper includes a perforation outlining the print side.

9. The printer of claim 8, wherein the self-stripping ledge separates the print side from the backing by catching on the perforation.

10. The self-separating apparatus of claim 1, wherein the self-stripping ledge separates the print side from the backing by catching on an indention.

11. The self-separating apparatus of claim 1, wherein the print side includes a printed indicia.

12. A self-separating apparatus for splitting a print side from a backing of paper, the apparatus comprising:
a rotating platen roller pulling a sheet of backings that have been separated from print sides;
a ribbon break shaft;
a self-stripping ledge within a printer that separates the print side from the backing at an angle created from the backing being pulled by the rotating platen roller and the ribbon break shaft abutting the print side.

13. The self-separating apparatus of claim 12, wherein the angle is 21.75 degrees that the print side is separated from the backing.

14. The self-separating apparatus of claim 12, wherein the angle is between 19 and 25 degrees that the print side is separated from the backing.

15. The self-separating apparatus of claim 12, further comprising a roller that pulls the print side with a tension created by the ribbon break shaft being in contact with the print side.

16. The self-separating apparatus of claim 12, wherein the self-strip ledge begins separating the print side from the backing by coming into contact with a perforation on the paper.

17. A method performed inside a printer for successively creating self-adhesive printed paper by separating a print side from a backing of the paper, the method comprising:
arcuately rotating a platen roller to pull previously separated backings of the paper across a roller and produce a tension in the backing;
using a ribbon break shaft to apply a force to previously separated print sides of the paper; and
feeding the paper to a self-splitting ledge that splits the print side from the back side of the paper at an angle created by the platen roller pulling the previously separated backings with the tension and the ribbon break shaft applying the force to the previously separated print sides.

18. The media of claim 17, wherein the angle that the print side is split from the back side is 21.75 degrees.

19. The media of claim 12, wherein the angle that the print side is split for the back side is between 19 and 25 degrees.

20. The one or more media of claim 13, further comprising:
ejecting the print side from the printer; and
collecting the backing in a roll of the previously separated backings.
